(19) United States
(12) Patent Application Publication
(10) Pub. No.: US 2009/0291318 A1
(43) Pub. Date: Nov. 26, 2009

(54) Composite material for electric and electronic components, electric and electronic components, and method for manufacturing composite material for electric and electronic components

(76) Inventors: Chikahito Sugahara, Tokyo (JP); Satoru Zama, Tokyo (JP)

Correspondence Address: Kazunao Kubotera;Kuboter & Associates, 200 Daingerfield Road Suite 202, Alexandria, VA, 22314, US

(21) Appl. No.: 12/448,529

(22) PCT Filed: Dec. 26, 2007
(86) PCT No.: PCT/JP2007/074960

§ 371 Date: Jun. 24, 2009

(30) Foreign Application Priority Data
Dec. 27, 2006 (JP) 2006-350875
Dec. 25, 2007 (JP) 2007-333316

(51) Int. Cl. B32B 15/08; C25D 5/10

(52) U.S. Cl. 428/603; 205/170

(57) ABSTRACT

The invention provides a composite material for an electric and electronic component, formed by punching, followed by bending. The composite material includes a metallic base material, an insulating film having a substantially single-layer structure provided on at least a part of the metallic base material, and a metal layer provided between the metallic base material and the insulating film so that a peeling width of the insulating film at the end of the material after punching is less than 10 μm. After bending, the adhesion of the insulating film on the inner side of the bent material is retained. The invention also provides the electric and electronic component using the composite material, and a method for manufacturing the composite material for the electric and electronic component.

### TECHNICAL FIELD

The present invention relates to a composite material for electric and electronic components provided with an electrical insulating film on a metallic base material, electric and electronic components, and a method for manufacturing a composite material for electric and electronic components.

### BACKGROUND ART

A metal material provided with an electric insulating film on a metallic base material (also referred to simply as an insulating film in the present invention) is utilized in, for example, a circuit board as a shielding material. The metal material is suitable for a case, a cover, a cap, and the likes, especially for a low height device container case (a height of an internal space is lowered).

In order to improve an adhesion between the metallic base material and the insulating film of the metal material with the insulating film, there have been methods, in which a coupling agent is applied on a surface of the metallic base material, or a plating layer having a dendrite crystal is formed on the surface of the metallic base material.

### DISCLOSURE OF THE INVENTION

When the metal material provided with the insulating film on the metallic base material is applied as a material for other electric and electronic components, since the insulating film is provided on the metallic base material, it is possible to arrange connector contacts with a narrow pitch through machining such as punching at a spot including an interface between the metallic base material and the insulating film to form the connector contacts. Accordingly, the material may be applicable to various applications. Further, when a bending process is carried out after the punching process, it is possible to apply the material to electric and electronic components having various functions.

When the machining such as the punching is carried out on the spot including the interface between the metallic base material and the insulating film, a slight gap of around several μm to several tens μm may be created between the metallic base material and the insulating film at the machined spot. FIG. 2 is a schematic view showing the case. In FIG. 2, an electric and electronic component 2 includes a metallic base material 21 and an insulating film 22, and a gap 23 is created between the metallic base material 21 and the insulating film 22 near a punched surface 21a of the metallic base material 21. The tendency increases when a clearance in the punching process becomes larger (for example, 5% or more relative to a thickness of the metallic base material). There is a practical limit to reduce the clearance in the punching process, so that the tendency may increase when a work-piece becomes smaller.

In the state described above, the insulating film 22 may be totally peeled off from the metallic base material 21 due to aging and the likes, and it is meaningless to provide the insulating film 22 on the metallic base material 21. Further, it is not practical to apply the insulating film after micromachining because it is extremely laborious, thus increasing costs of the product. When it is conceivable to use an exposed metal surface of the electric and electronic component thus formed (for example, the punched surface 21a) as the contact of the connector or the like, it is possible to form the metal layer on the exposed metal surface (for example, the punched surface 21a) through plating or the like in a later step. In this case, however, upon immersing in a plating solution, the plating solution may enter through the gap 23, thereby promoting the insulating film 22 to peel off from the metallic base material 21.

When a bending process is carried out after the punching process or the like, a gap may be created between the metallic base material and the insulating film after the bending process even if no gap is created between the metallic base material and the insulating film at a punched part in the punching process. FIG. 3 is a schematic view showing the state. In FIG. 3, an electric and electronic component 3 includes a metallic base material 31 and an insulating film 32, and has a gap 33 formed at an inner side of a bent part of the metallic base material 31 and a gap 34 formed at an end of the electric and electronic component 3 (in particular, an outer side of the electric and electronic component 3 upon bending). As shown in FIG. 3, the gaps 33 and 34 are created at a side surface and an inner surface of the bent part and at the end of the bent electric and electronic component. With the gaps 33 and 34, the insulating film 32 tends to peel off from the metallic base material 31.

In order to improve adhesion between the metallic base material and the insulating film, a method is adapted for applying a coupling agent on a surface of the metallic base material. In this case, a solution life of the coupling agent is short, and it is necessary to carefully control the solution. Further, it is difficult to homogeneously treat a whole surface of the metallic base material, so that it is difficult to obtain a sufficient effect relative to the small gap described above. When a method is adapted for forming a plated layer having a dendrite crystal on the surface of the metallic base material, it is necessary to plate under a strict plating condition to control a crystal state of the plated layer, and to carefully control. Further, it is necessary to increase a thickness of the plating in order to obtain enough adhesion, thereby making it not economical.

An object of the present invention is to provide a composite material for an electric and electronic component capable of maintaining high adhesion between a metallic base material and an insulating film even when a machining process such as a punching process is carried out on a part including an interface between the metallic base material and the insulating film. A further object of the present invention is to provide an electric and electronic component formed of the composite material, and a method of manufacturing the composite material for the electric and electronic component.

As a result of ardent study, the inventors have found that it is possible to obtain sufficient adhesion between a metallic base material and an insulating film when the insulating film is disposed on the metallic base material through a specific metal layer, regardless of a crystal state or a thickness of the metal layer, thereby reaching the present invention through further study.

The invention provides the following first through ninth solutions.

According to the first solution, a composite material for an electric and electronic component formed through a punching process followed by a bending process, comprises one layer of an insulating film disposed on at least a part of a metallic base material; and a metal layer disposed between the metal base material and the insulating film, so that the insulating film has a peel width of less than 10 μm at an end thereof after the punching process, and an adhesion state of the insulating film at a bending inner side thereof and an adhesion state of the insulating film at a bending outer side thereof are maintained after the bending process.

According to the second solution of the invention, in the first solution, the metallic base material is formed of a copper type material or a ferric type material.

According to the third solution of the invention, in the first or second solution, the metallic base material has a thickness of 0.04 to 0.4 mm.

According to the fourth solution of the invention, in the first solution, the metal layer is formed of a metal or an alloy of metals selected from the group consisting of Ni, Zn, Fe, Dr, Sn, Si, and Ti.

According to the fifth solution of the invention, in the first solution, the metal layer has a thickness of 0.001 to 0.5 μm.

According to the sixth solution of the invention, in one of the first through fifth solutions, the insulating film is formed of a thermosetting resin.

According to the seven solution, an electric and electronic component is formed such that the insulating film remains on the part of the metallic base material in a state in which a material for the electric and electronic component provided with the insulating film formed at least on a part of the metallic base material is bent after processed through the punching process, wherein the material for the electric and electronic component includes the composite material for the electric and electronic component in one of the first through sixth solutions.

According to the eighth solution, in the seventh solution, the electric and electronic component further comprises a portion where the insulating film is not provided and a wet post-processing is carried out in the state that the material for the electric and electronic component is bent after processed through the punching process.

According to the ninth solution, a method for manufacturing the composite material for the electric and electronic component according to one of the first through sixth solutions, in which the insulating film is provided at least on the part of the metallic base material, comprises the step of providing the metal layer on a surface of the metallic base material for improving adhesion between the metallic base material and the insulating film through plating and the likes to manufacture the composite material for the electric and electronic component.

In the invention, a specimen is punched out into a rectangular shape of 5 mm×10 mm using a die with a clearance of 5%, and the specific is immersed in an aqueous solution in which red ink is dissolved, so that the peel width of the insulating film at the end of the material after punching is measured.

Further, in the invention, it is possible to easily obtain the composite material for the electric and electronic component capable of maintaining the high adhesive between the metallic base material and the insulating film through the following configurations:

(1) The metallic base material is formed of a copper type material or a ferric type material.
(2) The metallic base material has a thickness of 0.04 to 0.4 mm.
(3) The metal layer is formed of a metal or an alloy of metals selected from the group consisting of Ni, Zn, Fe, Dr, Sn, Si, and Ti.
(4) The metal layer has a thickness of 0.001 to 0.5 μm.

The effects of the invention will be more apparent from the following description with reference to the accompanying drawings.

### BRIEF DESCRIPTION OF THE DRAWINGS

FIG. 1 is a section view showing one exemplary composite material for electric and electronic components according to an embodiment of the invention.

FIG. 2 is a schematic view showing one exemplary state in which gaps are created between a metallic base material and an insulating film.

FIG. 3 is a schematic view showing one exemplary state in which gaps are created between a metallic base material and an insulating film.

### BEST MODE FOR CARRYING OUT THE INVENTION

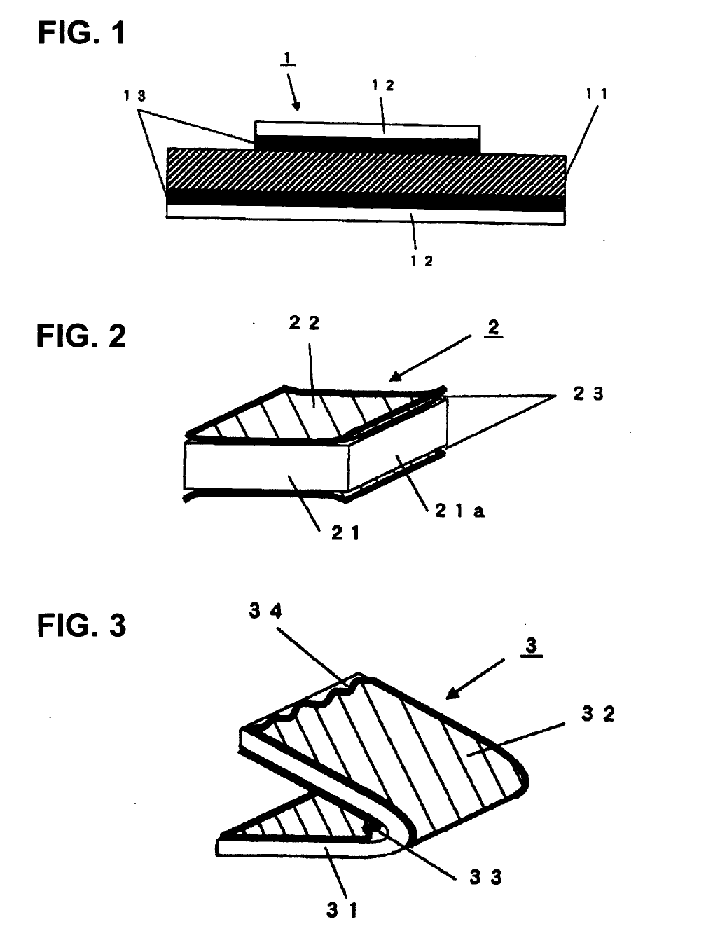

Embodiments of the present invention will be explained. FIG. 1 shows a cross-section of a composite material for electric and electronic components according to an embodiment of the invention. As shown in FIG. 1, the composite material for the electric and electronic components 1 is provided with an insulating film 12 on a metallic base material 11 and with metal layers 13 between the metallic base material 11 and the insulating film 12 to enhance adhesion thereof. The metal layer 13 enhances the adhesion of the metallic base material 11 and the insulating film 12, and is preferable in terms of realizing the composite material for the electric and electronic components 1 that excels in workability such as punching.

Although FIG. 1 shows the case in which the insulating film 12 is provided on part of an upper surface of the metallic base material 11 and on a whole lower surface of the metallic base material 11, this is one exemplary case to the end and the insulating film 12 may be provided on the whole upper and lower surfaces of the metallic base material 11 or may be provided on part of the upper and lower surfaces of the metallic base material 11. That is, the insulating film 12 is provided at least part of the metallic base material 11.

It is preferable to use a copper or iron type material for the metallic base material 11 from an aspect of electrical conductivity and others. Beside copper-based alloys such as phosphor bronze (Cu—Sn—P), brass (Cu—Zn), nickel silver (Cu—Ni—Zn), Corson alloy (Cu—Ni—Si), oxygen-free copper, tough pitch copper, phosphorous-deoxidized copper and others are also applicable as the copper material. Still more, iron-based alloys such as SUS (Fe—Cr—Ni) and 42 alloy (Fe—Ni) are also applicable as the iron material.

A thickness of the metallic base material 11 is preferable to be 0.04 mm or more because enough strength as the electric and electronic component cannot be assured if the thickness is thinner than 0.04 mm. Still more, the thickness is preferable to be less than 0.4 mm or more preferably, to be less than 0.3 mm because an absolute value of a clearance increases in punching and a shear droop of the punched part increases if the thickness is too large. Thus, an upper limit of the thickness of the metallic base material 11 is decided by taking the influences (such as the clearance and the size of the shear droop) of machining such as punching into consideration.

It is preferable for the insulating film 12 to have adequate insulation, so that it is preferable to use resin such as epoxy resin. It is also preferable to form it with heat-resistant resin such as polyimide resin and polyamide resin when it is used in an application requiring heat resistance in particular. Among such heat-resistant resins, a thermosetting resin is preferable.

While it is preferable to use the organic material such as the aforementioned synthetic resins as the material of the insulating film 12, the material of the insulating film 12 may be appropriately selected corresponding to required characteristics and others of the composite material for use in electric and electronic components 1. For instance, the base material of the organic material such as the synthetic resin added with additives (either organic or nonorganic material may be used) other than the base material and non-organic materials may be adopted.

A method of providing the insulating film 12 on the surface of the metallic base material 11 through the intermediary of the metal layer 13 includes such methods of (a) placing an adhesive-backed heat-resistant resin film at part of the metallic base material requiring insulation, of melting the adhesive by an induction heating roll and of then implementing a heat treatment to reactively harden and bond them and (b) of applying melt varnish at the part requiring the insulation by using resin or resin precursor as a solvent, of evaporating the solvent and of then implement a heat-treatment to reactively harden and bond them. It is preferable to use the method (b) described above for the composite material for use in electric and electronic components 1 of the embodiment of the invention because it is not necessary to consider the influences of the adhesive.

It is noted that a concrete example of the method (b) described above is a general technology in a method for manufacturing insulated electric cables and is known also in Japanese Patent Application Laid-open No. Hei. 05-130759. The gazette provides a plurality of layers of insulating coating and the present invention refers to this gazette as a reference technology.

Here, it is possible to repeat the method (b). It permits to fully evaporate the solvent and to reduce a possibility of generating bubbles between the insulating film 12 and the metal layer 13, so that the adhesion between the insulating film 12 and the metal layer 13 may be enhanced further. This method permits to provide substantially one layer of insulating film 12 on the metal layer 13 if the hardened resins formed separately in a plurality of times are substantially the same material.

Still more, when the insulating film 12 is to be provided on the part of the surface of the metallic base material 11, it is possible to adopt a manufacturing method that corresponds to a resin film forming accuracy level of the applied part such as a method of applying a roll coating facility for an offset (planographic) printing or a gravure (intaglio) printing, of applying coating of a photosensitive heat-resistant resin, pattern-forming by means of ultraviolet rays or electron beams and a resin hardening technology or of applying a micro-pattern forming technology applying etching and dissolution by an exposure phenomenon on a circuit board. Those methods make it easily possible to provide the insulating film 12 only on necessary parts of the surface of the metallic base material 11 and it becomes unnecessary to remove the insulating film 12 to connect the metallic base material 11 with other electric and electronic components or electric cables.

A thickness of the insulating film 12 is preferable to be from 2 to 20 μm and more preferably from 3 to 10 μm because it is unable to expect an insulating effect if the thickness is too thin and it becomes difficult to punch if the thickness is too thick.

The metal layer 13 is provided to enhance the adhesion between the metallic base material 11 and the insulating film 12 as described above. The adhesion of the metallic base material 11 and the insulating film 12 is preferable to be such that a peel width of the insulating film at the end of the material after punching is less than 10 μm or more preferably to be less than 5 μm.

The metal layer 13 is preferably formed by means of electroplating, chemical plating and the like and is preferably made of a metal selected among Ni, Zn, Fe, Cr, Sn, Si and Ti or of an alloy among those metals such as Ni—Zn alloy, Ni—Fe alloy and Fe—Cr alloy.

The metal layer 13 may be formed by means of wet or dry plating. The wet plating includes electrolytic plating and electroless plating methods for example. The dry plating includes physical vapor deposition and chemical vapor deposition methods for example.

A thickness of the metal layer 13 is preferable to be from 0.01 to 0.5 μm or more preferably from 0.005 to 0.5 μm because the adhesion of the metal layer 13 with the metallic base material 11 and the insulating film 12 is not enhanced if the thickness is too thin and because a possibility of causing cracks in the metal layer 13 increases if the thickness is too thick.

Still more, it is possible to implement a wet post-processing on part where no insulating film 12 is provided in the state in which the composite material for use in electric and electronic components 1 is bent after being machined by punching for example. The part where the insulating film 12 is not provided means sides of the metallic base material 11 in FIG. 1 and the part of the upper surface of the metallic base material 11 other than the part where the insulating film 12 is provided. A wet process used here includes wet plating (Ni plating, Sn plating, Au plating others), aqueous cleaning (acid pickling, alkali degreasing and others), solvent cleaning (supersonic cleaning and others) and others. For instance, although it is possible to protect the surface of the metallic base material 11 by proving a post-applied metal layer by means of the wet plating for example, the composite material for use in electric and electronic components 1 of the present embodiment has an advantage that the insulating film 12 does not peel from the metallic base material 11 even if the post-applied metal layer (not shown) is provided by the post-processing such as plating as a result of enhancing the adhesion between the metallic base material 11 and the insulating film 12.

While a thickness of the post-applied metal layer may be appropriately decided regardless of the thickness of the metal layer 13, its range may be from 0.001 to 0.5 μm in the same manner with the metal layer 13. Still more, while a metal used as the post-applied metal layer may be appropriately selected depending on uses of the electric and electronic component, it is preferable to be Au, Ag, Cu, Ni and Sn or an alloy containing them when the electric and electronic component is used as an electrical contact, a connector and the like.

According to the invention, the metal layer that enhances the adhesion between the metallic base material and the insulating film is interposed between the metallic base material and the insulating film, so that it is possible to keep the high adhesion between the metallic base material and the insulating film even if bending is carried out after punching the part including the interface of the metallic base material with the insulating film (specifically the interface of the metallic base material with the metal layer and the interface of the metal layer with the insulating film) and to obtain the composite material for the electric and electronic component that excels in the workability such as punching and bending.

Still more, the electric and electronic component of the invention is formed so that the insulating film is left on part of the metallic base material in the state in which the composite material provided with the insulating film at least on part of the metallic base material is bent after being punching and uses the material in which the metal layer that enhances the adhesion between the metallic base material and the insulating film as the composite material for use in the electric and electronic component, so that it is possible to readily obtain the electric and electronic component in which the insulating film adheres with the metallic base material through the metal layer and that excels in the workability such as punching and bending.

Further, because the metallic base material adheres tightly with the insulating film in the electric and electronic component of the invention, the insulating film will not peel from the metallic base material by providing the post-applied metal layer by means of the post-processing such as plating at the part where the insulating film is not provided.

The method of the invention for manufacturing the composite material for use in the electric and electronic component is carried out by providing the metal layer that enhances the adhesion between the metallic base material and the insulating film by means of plating or the like, so that it is possible to keep the high adhesion between the metallic base material and the insulating film even if bending is carried out after punching the part including the interface of the metallic base material with the insulating film (specifically the interface of the metallic base material with the metal layer and the interface of the metal layer with the insulating film) and to obtain the composite material for the electric and electronic component that excels in the workability such as punching and bending.

Although the invention will be explain in more detail below, the invention is not limited to them.

### EMBODIMENTS

### First Embodiment

### Explanation of Samples

As specific examples of the invention, the inventor, et al. implemented the electrolytic degreasing and acid pickling treatments in this order on metal strips (metallic base material) having a thickness of 0.1 mm and a width of 10 mm. Then, the inventor, et al. implemented Ni plating, Zn plating, Fe plating, Cr plating, Sn plating, Ni—Zn alloy plating, Ni—Fe alloy plating, Fe—Cr alloy plating, Si plating and Ti plating respectively with thicknesses of 0.001 μm, 0.005 μm, 0.01 μm, 0.05 μm, 0.1 μm and 0.5 μm and provided insulating coating layers at part of each strip requiring insulation to manufacture the composite materials for use in the electric and electronic components. The metal strip used was JIS alloy C5210R (phosphor bronze: made by the Furukawa Electric Co., Ltd.). It is noted that the inventor, et al. measured the plating thickness in terms of an average value of ten samples by using an X-ray fluorescence thickness meter SFT-3200 (made by Seiko-Epson Precision Co.).

Still more, beside those described above and as comparative examples, the inventor, et al. implemented the electrolytic degreasing and acid pickling treatments in this order and manufactured composite materials for use in electric and electronic components by providing the insulating coating layer at part requiring insulation without implementing plating. The inventor, et Al. also manufactured composite materials for use in electric and electronic components in the same manner with the examples described above except of plating by 1.0 μm as a still other comparative example.

(Various Conditions)

The electrolytic degreasing treatment was carried out by implementing cathode-electrolysis on the metal strip for 30 seconds under conditions of 60° C. of liquid temperature and 2.5 A/dm² of current density within a degreasing solution containing 60 g/l of cleaner 160S (made by Meltex Inc.).

The acid pickling treatment was carried out on the metal strip by soaking it into an acid pickling solution containing 100 g/l of sulfuric acid for 30 seconds in room temperature.

The Ni plating was carried out under conditions of 55° C. of liquid temperature and 10 A/dm² of current density within a plating solution containing 400 g/l of nickel sulfamite, 30 g/l of nickel chloride and 30 g/l of boric acid while adjusting a length of a plating tank and lining speed so that the plating grows to a predetermined thickness.

The Zn plating was carried out under conditions of 45° C. of liquid temperature and 20 A/dm² of current density within a plating solution containing 350 g/l of zinc sulfate and 30 g/l of ammonium sulfate while adjusting the length of the plating tank and lining speed so that the plating grows to a predetermined thickness.

The Fe plating was carried out under conditions of 60° C. of liquid temperature and 30 A/dm² of current density within a plating solution containing 400 g/l of ferric sulfate, 50 g/l of ammonium sulfate and 80 g/l of urea while adjusting the length of the plating tank and lining speed so that the plating grows to a predetermined thickness.

The Cr plating was carried out under conditions of 55° C. of liquid temperature and 20 A/dm² of current density within a plating solution containing 250 g/l of chromic anhydride and 2.5 g/l of sulfuric acid while adjusting the length of the plating tank and lining speed so that the plating grows to a predetermined thickness.

The Sn plating was carried out under conditions of 25° C. of liquid temperature and 2 A/dm² of current density within a plating solution containing 55 g/l of tin sulfate and 100 g/l of sulfuric acid while adjusting the length of the plating tank and lining speed so that the plating grows to a predetermined thickness.

The Ni—Zn alloy plating was carried out under conditions of 25° C. of liquid temperature and 0.2 A/dm² of current density within a plating solution containing 75 g/l of nickel chloride, 30 g/l of zinc chloride, 30 g/l of ammonium chloride and 15 g/l of sodium thiocyanate while adjusting the length of the plating tank and lining speed so that the plating grows to a predetermined thickness.

The Ni—Fe alloy plating was carried out under conditions of 50° C. of liquid temperature and 5 A/dm² of current density within a plating solution containing 250 g/l of nickel sulfate, 50 g/l of ferric sulfate and 30 g/l of boric acid while adjusting the length of the plating tank and lining speed so that the plating grows to a predetermined thickness.

The Fe—Cr alloy plating was carried out under conditions of 45° C. of liquid temperature and 20 A/dm² of current density within a plating solution containing 40 g/l of ferric sulfate, 120 g/l of chrome sulfate, 55 g/l of ammonium chloride and 40 g/l of boric acid while adjusting the length of the plating tank and lining speed so that the plating grows to a predetermined thickness.

The Si plating and the Ti plating were carried out by means of PVD by using a take-up type sputtering device SPW-069 (made by Alback Co.).

The insulating coating layer was formed by perpendicularly discharging varnish (fluid applied substance) on the surface of the running metallic base material out of a rectangular discharging port of an applicator and by heating it for 30 seconds at 300° C. The varnish was produced so that a thickness of the resin grows to a range from 8 to 10 μm by using a polyimide (PAI) solution using n-methyl 2-pyrolidone as solvent (made by Totoku Toryo Co. Ltd.). It is noted that the inventor et al. obtained the same results also from samples formed so that the thickness of the resin grows to the range from 8 to 10 μm by using a polyimide (PI) solution using n-methyl 2-pyrolidone (made by Arakawa Chemical Industries Ltd.) and an epoxy resin solution using methyl ethyl ketone (made by Dai Nippon Toryo Co., Ltd.).

(Evaluation Result)

The evaluation of the punching and bending workability of the composite materials for use in the electric and electronic components thus obtained was made as follows.

The punching workability was evaluated by punching through the samples into a rectangular shape of 5 mm×10 mm by using a die of 5% of clearance and by soaking the samples into an aqueous solution in which red ink is dissolved. Cases when the peel width of the resin at the punched end is less than 5 μm were denoted by a double circle, cases when the peel width is more than 5 μm and less than 10 μm are denoted by a circle and cases when the width is more than 10 μm are denoted by x.

The evaluation of the bending workability was determined by punching through the samples into the rectangular shape of 5 mm×10 mm by using the die of 5% of clearance and then by bending so that the samples are bent at position of 1 mm from the end of the samples by using a die having 0.1 mm of radius of curvature and 120 degrees of bending angle and by observing whether or not the resin is peeled at the bending inner side and whether or not the resin at the end portion to which the bending outer side is extended is peeled by an optical stereoscopic microscope of 40 times power. Cases when there is no peeling (those whose adhesion state of the resin are kept) are denoted by a circle and cases when there exist peeling (those whose adhesion state of the resin are not kept) are denoted by x. In the same time, it was observed whether or not there exist cracks of the plating substrate in the bent portion and the plating bending quality was evaluated by a circle and x. Table 1 shows those results.

TABLE 1

| | | | | | Evaluation of | |
|---|---|---|---|---|---|---|
| base material: phosphorus bronze | | | Thickness of | Evaluation of | Bonding | Plating |
| | | Type of | Plating | Punching | Workability | Bending |
| | Sample No. | Plating | [μm] | Workability | (inside/outside) | Workability |
| Present | 1 | Ni | 0.001 | ⊚ | ◯/◯ | ◯ |
| Invention | 2 | | 0.005 | ⊚ | ◯/◯ | ◯ |
| | 3 | | 0.01 | ⊚ | ◯/◯ | ◯ |
| | 4 | | 0.05 | ⊚ | ◯/◯ | ◯ |
| | 5 | | 0.1 | ⊚ | ◯/◯ | ◯ |
| | 6 | | 0.5 | ⊚ | ◯/◯ | ◯ |
| | 7 | Zn | 0.001 | ⊚ | ◯/◯ | ◯ |
| | 8 | | 0.005 | ⊚ | ◯/◯ | ◯ |
| | 9 | | 0.01 | ⊚ | ◯/◯ | ◯ |
| | 10 | | 0.05 | ⊚ | ◯/◯ | ◯ |
| | 11 | | 0.1 | ⊚ | ◯/◯ | ◯ |
| | 12 | | 0.5 | ⊚ | ◯/◯ | ◯ |
| | 13 | Fe | 0.001 | ◯ | ◯/◯ | ◯ |
| | 14 | | 0.005 | ◯ | ◯/◯ | ◯ |
| | 15 | | 0.01 | ◯ | ◯/◯ | ◯ |
| | 16 | | 0.05 | ⊚ | ◯/◯ | ◯ |
| | 17 | | 0.1 | ⊚ | ◯/◯ | ◯ |
| | 18 | | 0.5 | ◯ | ◯/◯ | ◯ |
| | 19 | Cr | 0.001 | ◯ | ◯/◯ | ◯ |
| | 20 | | 0.005 | ◯ | ◯/◯ | ◯ |
| | 21 | | 0.01 | ◯ | ◯/◯ | ◯ |
| | 22 | | 0.05 | ⊚ | ◯/◯ | ◯ |
| | 23 | | 0.1 | ⊚ | ◯/◯ | ◯ |
| | 24 | | 0.5 | ◯ | ◯/◯ | ◯ |
| | 25 | Sn | 0.001 | ◯ | ◯/◯ | ◯ |
| | 26 | | 0.005 | ⊚ | ◯/◯ | ◯ |
| | 27 | | 0.01 | ⊚ | ◯/◯ | ◯ |
| | 28 | | 0.05 | ⊚ | ◯/◯ | ◯ |
| | 29 | | 0.1 | ⊚ | ◯/◯ | ◯ |
| | 30 | | 0.5 | ◯ | ◯/◯ | ◯ |
| | 31 | Ni—Zn | 0.001 | ⊚ | ◯/◯ | ◯ |
| | 32 | | 0.005 | ⊚ | ◯/◯ | ◯ |
| | 33 | | 0.01 | ⊚ | ◯/◯ | ◯ |
| | 34 | | 0.05 | ⊚ | ◯/◯ | ◯ |
| | 35 | | 0.1 | ⊚ | ◯/◯ | ◯ |
| | 36 | | 0.5 | ◯ | ◯/◯ | ◯ |
| | 37 | Ni—Fe | 0.001 | ◯ | ◯/◯ | ◯ |
| | 38 | | 0.005 | ⊚ | ◯/◯ | ◯ |
| | 39 | | 0.01 | ⊚ | ◯/◯ | ◯ |
| | 40 | | 0.05 | ⊚ | ◯/◯ | ◯ |
| | 41 | | 0.1 | ⊚ | ◯/◯ | ◯ |
| | 42 | | 0.5 | ◯ | ◯/◯ | ◯ |
| | 43 | Fe—Cr | 0.001 | ◯ | ◯/◯ | ◯ |
| | 44 | | 0.005 | ◯ | ◯/◯ | ◯ |
| | 45 | | 0.01 | ◯ | ◯/◯ | ◯ |
| | 46 | | 0.05 | ⊚ | ◯/◯ | ◯ |
| | 47 | | 0.1 | ⊚ | ◯/◯ | ◯ |
| | 48 | | 0.5 | ◯ | ◯/◯ | ◯ |
| | 49 | Si | 0.001 | ◯ | ◯/◯ | ◯ |
| | 50 | | 0.005 | ◯ | ◯/◯ | ◯ |
| | 51 | | 0.01 | ⊚ | ◯/◯ | ◯ |
| | 52 | | 0.05 | ⊚ | ◯/◯ | ◯ |
| | 53 | | 0.1 | ⊚ | ◯/◯ | ◯ |
| | 54 | | 0.5 | ◯ | ◯/◯ | ◯ |
| | 55 | Ti | 0.001 | ◯ | ◯/◯ | ◯ |
| | 56 | | 0.005 | ⊚ | ◯/◯ | ◯ |
| | 57 | | 0.01 | ⊚ | ◯/◯ | ◯ |
| | 58 | | 0.05 | ⊚ | ◯/◯ | ◯ |
| | 59 | | 0.1 | ⊚ | ◯/◯ | ◯ |
| | 60 | | 0.5 | ◯ | ◯/◯ | ◯ |
| Comparative | 61 | Non-Plated | | X | X/X | — |
| Examples | 62 | Ni | 1 | ⊚ | ◯/◯ | X |
| | 63 | Zn | 1 | ⊚ | ◯/◯ | X |
| | 64 | Fe | 1 | ⊚ | ◯/◯ | X |
| | 65 | Cr | 1 | ⊚ | ◯/◯ | X |
| | 66 | Sn | 1 | ⊚ | ◯/◯ | X |
| | 67 | Ni—Zn | 1 | ⊚ | ◯/◯ | X |
| | 68 | Ni—Fe | 1 | ⊚ | ◯/◯ | X |
| | 69 | Fe—Cr | 1 | ⊚ | ◯/◯ | X |
| | 70 | Si | 1 | ⊚ | ◯/◯ | X |
| | 71 | Ti | 1 | ⊚ | ◯/◯ | X |

The sample No. 61 of the comparative examples has inferior punching and bending workability of the resin because no base plating process is implemented. Although the comparative examples 62 through 71 excel in the punching bending workability of the resin, the plating part cracks because the plating layer is thick. In contrary, the sample Nos. 1 through 60 of the invention excel in the punching and bending workability of the resin and the plating part causes no cracks, so that they are suitable for use in those machined by a precision press and are even more suitable for use in those requiring bending. Specifically, the sample Nos. 1 through 12 on which the Ni plating and the Zn plating were implemented bring about excellent effects even in the regions where the thickness of the plating is thin.

### Second Embodiment

The evaluation was carried out in the same manner with the first embodiment except of that JIS alloy C7701 (nickel silver, made by Mitsubishi Metex Co., Ltd.) was used as the metal strip. Table 2 shows its results.

TABLE 2

| | | | | | Evaluation of | |
|---|---|---|---|---|---|---|
| base material: nickel silver | | | Thickness of | Evaluation of | Bonding | Plating |
| | | Type of | Plating | Punching | Workability | Bending |
| | Sample No. | Plating | [μm] | Workability | (inside/outside) | Workability |
| Present | 72 | Ni | 0.001 | ⊚ | ◯/◯ | ◯ |
| Invention | 73 | | 0.005 | ⊚ | ◯/◯ | ◯ |
| | 74 | | 0.01 | ⊚ | ◯/◯ | ◯ |
| | 75 | | 0.05 | ⊚ | ◯/◯ | ◯ |
| | 76 | | 0.1 | ⊚ | ◯/◯ | ◯ |
| | 77 | | 0.5 | ⊚ | ◯/◯ | ◯ |
| | 78 | Zn | 0.001 | ⊚ | ◯/◯ | ◯ |
| | 79 | | 0.005 | ⊚ | ◯/◯ | ◯ |
| | 80 | | 0.01 | ⊚ | ◯/◯ | ◯ |
| | 81 | | 0.05 | ⊚ | ◯/◯ | ◯ |
| | 82 | | 0.1 | ⊚ | ◯/◯ | ◯ |
| | 83 | | 0.5 | ⊚ | ◯/◯ | ◯ |
| | 84 | Fe | 0.001 | ◯ | ◯/◯ | ◯ |
| | 85 | | 0.005 | ◯ | ◯/◯ | ◯ |
| | 86 | | 0.01 | ◯ | ◯/◯ | ◯ |
| | 87 | | 0.05 | ⊚ | ◯/◯ | ◯ |
| | 88 | | 0.1 | ⊚ | ◯/◯ | ◯ |
| | 89 | | 0.5 | ◯ | ◯/◯ | ◯ |
| | 90 | Cr | 0.001 | ◯ | ◯/◯ | ◯ |
| | 91 | | 0.005 | ◯ | ◯/◯ | ◯ |
| | 92 | | 0.01 | ⊚ | ◯/◯ | ◯ |
| | 93 | | 0.05 | ⊚ | ◯/◯ | ◯ |
| | 94 | | 0.1 | ⊚ | ◯/◯ | ◯ |
| | 95 | | 0.5 | ◯ | ◯/◯ | ◯ |
| | 96 | Sn | 0.001 | ◯ | ◯/◯ | ◯ |
| | 97 | | 0.005 | ◯ | ◯/◯ | ◯ |
| | 98 | | 0.01 | ◯ | ◯/◯ | ◯ |
| | 99 | | 0.05 | ⊚ | ◯/◯ | ◯ |
| | 100 | | 0.1 | ⊚ | ◯/◯ | ◯ |
| | 101 | | 0.5 | ◯ | ◯/◯ | ◯ |
| | 102 | Ni—Zn | 0.001 | ⊚ | ◯/◯ | ◯ |
| | 103 | | 0.005 | ⊚ | ◯/◯ | ◯ |
| | 104 | | 0.01 | ⊚ | ◯/◯ | ◯ |
| | 105 | | 0.05 | ⊚ | ◯/◯ | ◯ |
| | 106 | | 0.1 | ⊚ | ◯/◯ | ◯ |
| | 107 | | 0.5 | ◯ | ◯/◯ | ◯ |
| | 108 | Ni—Fe | 0.001 | ◯ | ◯/◯ | ◯ |
| | 109 | | 0.005 | ⊚ | ◯/◯ | ◯ |
| | 110 | | 0.01 | ⊚ | ◯/◯ | ◯ |
| | 111 | | 0.05 | ⊚ | ◯/◯ | ◯ |
| | 112 | | 0.1 | ⊚ | ◯/◯ | ◯ |
| | 113 | | 0.5 | ◯ | ◯/◯ | ◯ |
| | 114 | Fe—Cr | 0.001 | ◯ | ◯/◯ | ◯ |
| | 115 | | 0.005 | ◯ | ◯/◯ | ◯ |
| | 116 | | 0.01 | ◯ | ◯/◯ | ◯ |
| | 117 | | 0.05 | ⊚ | ◯/◯ | ◯ |
| | 118 | | 0.1 | ⊚ | ◯/◯ | ◯ |
| | 119 | | 0.5 | ◯ | ◯/◯ | ◯ |
| | 120 | Si | 0.001 | ◯ | ◯/◯ | ◯ |
| | 121 | | 0.005 | ◯ | ◯/◯ | ◯ |
| | 122 | | 0.01 | ⊚ | ◯/◯ | ◯ |
| | 123 | | 0.05 | ⊚ | ◯/◯ | ◯ |
| | 124 | | 0.1 | ⊚ | ◯/◯ | ◯ |
| | 125 | | 0.5 | ◯ | ◯/◯ | ◯ |
| | 126 | Ti | 0.001 | ◯ | ◯/◯ | ◯ |
| | 127 | | 0.005 | ⊚ | ◯/◯ | ◯ |
| | 128 | | 0.01 | ⊚ | ◯/◯ | ◯ |
| | 129 | | 0.05 | ⊚ | ◯/◯ | ◯ |
| | 130 | | 0.1 | ⊚ | ◯/◯ | ◯ |
| | 131 | | 0.5 | ◯ | ◯/◯ | ◯ |
| Comparative | 132 | Non-Plated | | X | X/X | — |
| EXamples | 133 | Ni | 1 | ⊚ | ◯/◯ | X |
| | 134 | Zn | 1 | ⊚ | ◯/◯ | X |
| | 135 | Fe | 1 | ⊚ | ◯/◯ | X |
| | 136 | Cr | 1 | ⊚ | ◯/◯ | X |
| | 137 | Sn | 1 | ⊚ | ◯/◯ | X |
| | 138 | Ni—Zn | 1 | ⊚ | ◯/◯ | X |
| | 139 | Ni—Fe | 1 | ⊚ | ◯/◯ | X |
| | 140 | Fe—Cr | 1 | ⊚ | ◯/◯ | X |
| | 141 | Si | 1 | ⊚ | ◯/◯ | X |
| | 142 | Ti | 1 | ⊚ | ◯/◯ | X |

The sample No. 132 of the comparative examples has inferior punching and bending workability of the resin because no base plating process is implemented. Although the comparative examples 132 through 142 excel in the punching bending workability of the resin, the plating part cracks because the plating layer is thick. In contrary, the sample Nos. 72 through 131 of the invention excel in the punching and bending workability of the resin and the plating part causes no cracks, so that they are suitable for use in those machined by a precision press and are even more suitable for use in those requiring bending. Specifically, the sample Nos. 72 through 83 on which the Ni plating and the Zn plating were implemented bring about excellent effects even in the regions where the thickness of the plating is thin. That is, the sample Nos. 72 through 131 of the second embodiment excel in the punching workability of the resin in the same manner with the first embodiment, so that they are suitable in the use of those machined by the precision press and more suitable in the use of those requiring bending.

### Second Embodiment

The evaluation was carried out in the same manner with the first embodiment except of that SUS304-CPS (stainless, made by Nisshi Steel Co., Ltd.) was used as the metal strip. Table 3 shows its results.

TABLE 3

| | | | | | Evaluation of | |
|---|---|---|---|---|---|---|
| base material: stainless steel | | | Thickness of | Evaluation of | Bonding | Plating |
| | | Type of | Plating | Punching | Workability | Bending |
| | Sample No. | Plating | [μm] | Workability | (inside/outside) | Workability |
| Present | 143 | Ni | 0.001 | ⊚ | ◯/◯ | ◯ |
| Invention | 144 | | 0.005 | ⊚ | ◯/◯ | ◯ |
| | 145 | | 0.01 | ⊚ | ◯/◯ | ◯ |
| | 146 | | 0.05 | ⊚ | ◯/◯ | ◯ |
| | 147 | | 0.1 | ⊚ | ◯/◯ | ◯ |
| | 148 | | 0.5 | ⊚ | ◯/◯ | ◯ |
| | 149 | Zn | 0.001 | ⊚ | ◯/◯ | ◯ |
| | 150 | | 0.005 | ⊚ | ◯/◯ | ◯ |
| | 151 | | 0.01 | ⊚ | ◯/◯ | ◯ |
| | 152 | | 0.05 | ⊚ | ◯/◯ | ◯ |
| | 153 | | 0.1 | ⊚ | ◯/◯ | ◯ |
| | 154 | | 0.5 | ◯ | ◯/◯ | ◯ |
| | 155 | Fe | 0.001 | ◯ | ◯/◯ | ◯ |
| | 156 | | 0.005 | ⊚ | ◯/◯ | ◯ |
| | 157 | | 0.01 | ⊚ | ◯/◯ | ◯ |
| | 158 | | 0.05 | ⊚ | ◯/◯ | ◯ |
| | 159 | | 0.1 | ⊚ | ◯/◯ | ◯ |
| | 160 | | 0.5 | ◯ | ◯/◯ | ◯ |
| | 161 | Cr | 0.001 | ◯ | ◯/◯ | ◯ |
| | 162 | | 0.005 | ⊚ | ◯/◯ | ◯ |
| | 163 | | 0.01 | ⊚ | ◯/◯ | ◯ |
| | 164 | | 0.05 | ⊚ | ◯/◯ | ◯ |
| | 165 | | 0.1 | ⊚ | ◯/◯ | ◯ |
| | 166 | | 0.5 | ◯ | ◯/◯ | ◯ |
| | 167 | Sn | 0.001 | ◯ | ◯/◯ | ◯ |
| | 168 | | 0.005 | ◯ | ◯/◯ | ◯ |
| | 169 | | 0.01 | ◯ | ◯/◯ | ◯ |
| | 170 | | 0.05 | ⊚ | ◯/◯ | ◯ |
| | 171 | | 0.1 | ⊚ | ◯/◯ | ◯ |
| | 172 | | 0.5 | ◯ | ◯/◯ | ◯ |
| | 173 | Ni—Zn | 0.001 | ⊚ | ◯/◯ | ◯ |
| | 174 | | 0.005 | ⊚ | ◯/◯ | ◯ |
| | 175 | | 0.01 | ⊚ | ◯/◯ | ◯ |
| | 176 | | 0.05 | ⊚ | ◯/◯ | ◯ |
| | 177 | | 0.1 | ⊚ | ◯/◯ | ◯ |
| | 178 | | 0.5 | ◯ | ◯/◯ | ◯ |
| | 179 | Ni—Fe | 0.001 | ◯ | ◯/◯ | ◯ |
| | 180 | | 0.005 | ⊚ | ◯/◯ | ◯ |
| | 181 | | 0.01 | ⊚ | ◯/◯ | ◯ |
| | 182 | | 0.05 | ⊚ | ◯/◯ | ◯ |
| | 183 | | 0.1 | ⊚ | ◯/◯ | ◯ |
| | 184 | | 0.5 | ◯ | ◯/◯ | ◯ |
| | 185 | Fe—Cr | 0.001 | ◯ | ◯/◯ | ◯ |
| | 186 | | 0.005 | ⊚ | ◯/◯ | ◯ |
| | 187 | | 0.01 | ⊚ | ◯/◯ | ◯ |
| | 188 | | 0.05 | ⊚ | ◯/◯ | ◯ |
| | 189 | | 0.1 | ⊚ | ◯/◯ | ◯ |
| | 190 | | 0.5 | ◯ | ◯/◯ | ◯ |
| | 191 | Si | 0.001 | ◯ | ◯/◯ | ◯ |
| | 192 | | 0.005 | ◯ | ◯/◯ | ◯ |
| | 193 | | 0.01 | ⊚ | ◯/◯ | ◯ |
| | 194 | | 0.05 | ⊚ | ◯/◯ | ◯ |
| | 195 | | 0.1 | ⊚ | ◯/◯ | ◯ |
| | 196 | | 0.5 | ◯ | ◯/◯ | ◯ |
| | 197 | Ti | 0.001 | ◯ | ◯/◯ | ◯ |
| | 198 | | 0.005 | ◯ | ◯/◯ | ◯ |
| | 199 | | 0.01 | ⊚ | ◯/◯ | ◯ |
| | 200 | | 0.05 | ⊚ | ◯/◯ | ◯ |
| | 201 | | 0.1 | ⊚ | ◯/◯ | ◯ |
| | 202 | | 0.5 | ◯ | ◯/◯ | ◯ |
| Comparative | 203 | Non-Plated | | X | X/X | — |
| EXamples | 204 | Ni | 1 | ⊚ | ◯/◯ | X |
| | 205 | Zn | 1 | ⊚ | ◯/◯ | X |
| | 206 | Fe | 1 | ⊚ | ◯/◯ | X |
| | 207 | Cr | 1 | ⊚ | ◯/◯ | X |
| | 208 | Sn | 1 | ⊚ | ◯/◯ | X |
| | 209 | Ni—Zn | 1 | ⊚ | ◯/◯ | X |
| | 210 | Ni—Fe | 1 | ⊚ | ◯/◯ | X |
| | 211 | Fe—Cr | 1 | ⊚ | ◯/◯ | X |
| | 212 | Si | 1 | ⊚ | ◯/◯ | X |
| | 213 | Ti | 1 | ⊚ | ◯/◯ | X |

The sample No. 203 of the comparative examples has inferior punching and bending workability of the resin because no base plating process is implemented. Although the comparative examples No. 204 through 213 excel in the punching bending workability of the resin, the plating part cracks because the plating layer is thick. In contrary, the sample Nos. 143 through 202 of the invention excel in the punching and bending workability of the resin and the plating part causes no cracks, so that they are suitable for use in those machined by the precision press and are even more suitable for use in those requiring bending. Specifically, the sample Nos. 143 through 152 on which the Ni plating and the Zn plating were implemented bring about excellent effects even in the regions where the thickness of the plating is thin. That is, the sample Nos. 143 through 202 of the third embodiment excel in the punching workability of the resin in the same manner with the first embodiment, so that they are suitable in the use of those machined by the precision press and more suitable in the use of those requiring bending.

### INDUSTRIAL APPLICABILITY

The composite material for use in the electric and electronic components of the invention keeps the high adhesion state of the metallic base material and the insulating film even if the bending is implemented after punching at the part including the interface between the metallic base material and the insulating film, so that it is suitable as the composite material for use in the electric and electronic component that excels in the workability such as punching and bending.

Although the invention has been explained in conjunction with the embodiments thereof, the invention does not limit any detail of the explanation thereof unless specifically specified and the invention described in the appended Claims should be widely construed without departing from the sprit and scope described in the appended Claims.

The present application claims the foreign priority benefit of Japanese Patent Application No. 2006-350875, filed on Dec. 27, 2006 in the Japan Patent Office and Japanese Patent Application No. 2007-333316, filed on Dec. 25, 2007 in the Japan Patent Office, the disclosures of which are herein incorporated by reference in its entirety.

1. A composite material for an electric and electronic component formed through a punching process followed by a bending process, comprising:
one layer of an insulating film disposed on at least a part of a metallic base material; and
a metal layer disposed between the metal base material and the insulating film so that the insulating film has a peel width of less than 10 μm at an end thereof after the punching process, and an adhesion state of the insulating film at a bending inner side thereof and an adhesion state of the insulating film at a bending outer side thereof are maintained after the bending process.

2. The composite material for the electric and electronic component according to claim 1, wherein said metallic base material is formed of a copper type material or a ferric type material.

3. The composite material for the electric and electronic component according to claim 1, wherein said metallic base material has a thickness of 0.04 to 0.4 mm.

4. The composite material for the electric and electronic component according to claim 1, wherein said metal layer is formed of a metal or an alloy of metals selected from the group consisting of Ni, Zn, Fe, Dr, Sn, Si, and Ti.

5. The composite material for the electric and electronic component according to claim 4, wherein said metal layer has a thickness of 0.001 to 0.5 μm.

6. The composite material for the electric and electronic component according to claim 1, wherein said insulating film is formed of a thermosetting resin.

7. An electric and electronic component formed such that the insulating film remains on the part of the metallic base material in a state in which a material for the electric and electronic component provided with the insulating film formed at least on a part of the metallic base material is bent after processed through the punching process, wherein said material for the electric and electronic component includes the composite material for the electric and electronic component according to claim 1.

8. The electric and electronic component according to claim 7, further comprising a portion where the insulating film is not provided and a wet post-processing is carried out in the state that the material for the electric and electronic component is bent after processed through the punching process.

9. A method for manufacturing the composite material for the electric and electronic component according to claim 1, in which the insulating film is provided at least on the part of the metallic base material, comprising the step of providing the metal layer on a surface of the metallic base material for improving adhesion between the metallic base material and the insulating film through plating and the likes to manufacture the composite material for the electric and electronic component.
